(19) United States
(12) Patent Application Publication
(10) Pub. No.: US 2020/0143417 A1
(43) Pub. Date: May 7, 2020

(54) BIG DATA ADVERTISEMENT SYSTEM AND METHOD FOR ADVERTISING BY MEANS OF BACK OF CASH REGISTER PAPER

(71) Applicant: GUANGZHOU ZONERICH BUSINESS MACHINE CO., LTD., Guangzhou (CN)

(72) Inventor: Liqiang LIU, Guangzhou (CN)

(21) Appl. No.: 16/627,607

(22) PCT Filed: Jul. 17, 2017
(86) PCT No.: PCT/CN2017/093080

§ 371 Date: Jan. 24, 2020

(30) Foreign Application Priority Data
Jun. 30, 2017 (CN) 201710519183.1

(51) Int. Cl. G06Q 30/02; G06Q 20/20

(52) U.S. Cl. CPC G06Q 30/0253; G06Q 20/209

(57) ABSTRACT

Disclosed is a big data advertisement system and method for advertising through a back of cash register paper. The system comprises a cloud advertisement server, at least one advertisement releasing terminal, and a plurality of double-sided printers, wherein the cloud advertisement server is configured for receiving advertisement information sent by the advertisement releasing terminal, generating corresponding advertisement pushing information, and then sending the corresponding advertisement pushing information to the double-sided printers, and also configured for outputting an intelligent maintenance advice or advertisement statistical information, the double-sided printers are configured for receiving the advertisement pushing information and printing the corresponding advertisement information on the back of the cash register paper when printing cashier information, and sending real-time working parameters and real-time printing data to the cloud advertisement server.

### TECHNICAL FIELD

The present disclosure relates to the field of information processing, and more particularly, to a big data advertisement system and method for advertising through a back of cash register paper.

### BACKGROUND

At present, generally speaking, a back of cash register paper is blank. If an advertisement needs to be printed on the back of the cash register paper, the advertisement is printed on the back of the cash register paper in advance according to the prior art after advertisement contents are customized by a customer, and then the cash register paper is put into a checkout counter for use. This method needs to collect the advertisement contents in advance, and then needs to perform a plurality of links such as transportation, printing, cash register paper distribution and the like, which consumes more manpower and material resources and has a longer time period. Moreover, the advertisement contents printed by the method are fixed and cannot be changed after being printed on the back of the cash register paper, which is easy to cause invalid advertisements, spam advertisements and the like, the advertisement information has a poor timeliness, and cannot be updated in time or released as soon as possible. In addition, according to the method, working conditions of all printers cannot be counted in time and the advertisement information is difficult to be counted, such as advertisement sending times and the like, so that it is difficult to meet current application requirements.

### SUMMARY

In order to address the technical problems above, the present disclosure is intended to provide a big data advertisement system for advertising through a back of cash register paper, and the present disclosure is further intended to provide a big data advertisement method for advertising through a back of cash register paper.

The technical solution used in the present disclosure to solve the technical problems thereof is as follows.

A big data advertisement system for advertising through a back of cash register paper comprises a cloud advertisement server, at least one advertisement releasing terminal, and a plurality of double-sided printers, wherein the cloud advertisement server is respectively and wirelessly connected with the advertisement releasing terminal and the double-sided printers;

the advertisement releasing terminal is configured for receiving advertisement content(s) input by a user, generating advertisement information, and then sending the advertisement information to the cloud advertisement server;

the cloud advertisement server is configured for receiving the advertisement information sent by the advertisement releasing terminal, generating corresponding advertisement pushing information, and then sending the corresponding advertisement pushing information to the double-sided printers, and also configured for performing cloud statistics on real-time working parameters and real-time printing data of the double-sided printers, and then outputting an intelligent maintenance advice or advertisement statistical information; and

the double-sided printers are configured for receiving the advertisement pushing information and printing the corresponding advertisement information on a back of cash register paper when printing cashier information, and sending the real-time working parameters and the real-time printing data to the cloud advertisement server.

Further, the real-time working parameters of the double-sided printer include printing parameters and working parameters of various spare parts, and the real-time printing data comprises commodity information, printing time and printed advertisement contents.

Further, the real-time printing data also comprises coupon consumption information.

Further, the cloud advertisement server is configured for counting the printing parameters of the double-sided printers and the working parameters of various spare parts, and then analyzing to obtain service lives of the spare parts of the double-sided printer, a maintenance advice on the spare part, or an amending advice on the printing parameters.

Further, the cloud advertisement server is configured for counting the real-time printing data of the double-sided printers, and then calculating to obtain a main printing period, an advertisement printing ratio and an advertisement vacancy rate of the double-sided printers, and also configured for counting advertisement times of various advertisement contents printed by the double-sided printers and counting coupon consumption times corresponding to each advertisement content according to the coupon consumption information, and then calculating to obtain an advertisement feedback rate of each advertisement content.

Further, a sum of the advertisement printing ratio and the advertisement vacancy rate is 1, and a calculation method of the advertisement printing ratio is: total advertisement printing times/total printing times of the double-sided printer.

Another technical solution used in the present disclosure to solve the technical problems thereof is as follows.

A big data advertisement method for advertising through a back of cash register paper comprises the following steps of:

receiving, by an advertisement releasing terminal, advertisement contents input by a user, generating advertisement information, and then sending the advertisement information to a cloud advertisement server;

receiving, by the cloud advertisement server, the advertisement information sent by the advertisement releasing terminal, then generating corresponding advertisement pushing information, and sending the advertisement pushing information to double-sided printers;

receiving, by the double-sided printers, the advertisement pushing information, analyzing the advertisement pushing information, printing the corresponding advertisement information on a back of cash register paper when printing cashier information, and sending real-time working parameters and real-time printing data to the cloud advertisement server; and

performing cloud statistics, by the cloud advertisement server, on the real-time working parameters and the real-time printing data of the double-sided printers, and outputting an intelligent maintenance advice or advertisement statistical information.

Further, the real-time working parameters of the double-sided printer include printing parameters and working parameters of various spare parts, the real-time printing data comprises commodity information, printing time and printed advertisement contents, and the step of performing the cloud statistics, by the cloud advertisement server, on the real-time working parameters and the real-time printing data of the double-sided printers, and outputting the intelligent maintenance advice or the advertisement statistical information specifically comprises:

counting, by the cloud advertisement server, the printing parameters of the double-sided printers and the working parameters of various spare parts, then analyzing to obtain service lives of the spare parts of the double-sided printer, a maintenance advice on the spare parts, or an amending advice on the printing parameters, and correspondingly sending the service lives, the maintenance advice or the amending advice to the double-sided printers or a control terminal thereof;

or,

counting, by the cloud advertisement server, the real-time printing data of the double-sided printers, then calculating to obtain a main printing period, an advertisement printing ratio and an advertisement vacancy rate of the double-sided printers, and outputting the main printing period, the advertisement printing ratio and the advertisement vacancy rate to each advertisement releasing terminal.

Further, the real-time printing data also comprises coupon consumption information, and the big data advertisement method also comprises the following steps of:

counting, by the cloud advertisement server, advertisement times of various advertisement contents printed by the double-sided printers and counting coupon consumption times corresponding to each advertisement content according to the coupon consumption information, and then calculating to obtain an advertisement feedback rate of each advertisement content.

Further, in the advertisement pushing information pushed by the cloud advertisement server, each advertisement content has a corresponding advertisement code, and a data format of the real-time printing data is composed of an identification code, an advertisement identification, a data content, an advertisement code and local time information, the identification code is unique identification code of the double-sided printer, and the advertisement identification is configured for identifying whether the printing data contains the advertisement contents.

Further, the step of receiving, by the cloud advertisement server, the advertisement information sent by the advertisement releasing terminal, then generating the corresponding advertisement pushing information, and sending the advertisement pushing information to the double-sided printers specifically comprises:

receiving, by the cloud advertisement server, the advertisement information sent by the advertisement releasing terminal, then generating the corresponding advertisement pushing information, analyzing the advertisement contents in the advertisement pushing information, selecting an appropriate double-sided printer as a pushing object according to the advertisement statistical information of the double-sided printers, and sending the advertisement pushing information to all the selected double-sided printers.

Further, a sum of the advertisement printing ratio and the advertisement vacancy rate is 1, and a calculation method of the advertisement printing ratio is: total advertisement printing times/total printing times of the double-sided printer.

The present disclosure has the beneficial effects that: the big data advertisement system for advertising through the back of the cash register paper comprises the cloud advertisement server, the at least one advertisement releasing terminal, and the plurality of double-sided printers, wherein the cloud advertisement server is respectively and wirelessly connected with the advertisement releasing terminal and the double-sided printers; the advertisement releasing terminal is configured for receiving the advertisement contents input by the user, generating the advertisement information, and then sending the advertisement information to the cloud advertisement server; the cloud advertisement server is configured for receiving the advertisement information sent by the advertisement releasing terminal, generating the corresponding advertisement pushing information, and then sending the corresponding advertisement pushing information to the double-sided printers, and also configured for performing the cloud statistics on the real-time working parameters and the real-time printing data of the double-sided printers, and then outputting the intelligent maintenance advice or the advertisement statistical information; and the double-sided printers are configured for receiving the advertisement pushing information and printing the corresponding advertisement information on the back of the cash register paper when printing the cashier information, and sending the real-time working parameters and the real-time printing data to the cloud advertisement server. The system can timely send the advertisement information to be sent to the double-sided printer for printing, can print various advertisement information without consuming a large amount of manpower and material resources in advance for printing, is environment-friendly and high in timeliness, and can meet requirements of the advertisement information pushing. Moreover, after the cloud statistics is performed on the real-time printing data and the real-time working parameters, the intelligent maintenance advice or the advertisement statistical information can be outputted, the working states of the double-sided printers and the advertisement statistical information can be fed back in time, a degree of intelligence is high, and the system is efficient and fast.

The present disclosure has another beneficial effect that: the big data advertisement method for advertising through the back of the cash register paper comprises the following steps of: receiving, by the advertisement releasing terminal, the advertisement contents input by the user, generating the advertisement information, and then sending the advertisement information to the cloud advertisement server; receiving, by the cloud advertisement server, the advertisement information sent by the advertisement releasing terminal, then generating the corresponding advertisement pushing information, and sending the advertisement pushing information to the double-sided printers; receiving, by the double-sided printers, the advertisement pushing information, analyzing the advertisement pushing information, printing the corresponding advertisement information on the back of cash register paper when printing the cashier information, and sending the real-time working parameters and the real-time printing data to the cloud advertisement server; and performing the cloud statistics, by the cloud advertisement server, on the real-time working parameters and the real-time printing data of the double-sided printers, and outputting the intelligent maintenance advice or the advertisement statistical information. The method can timely send the advertisement information to be sent to the double-sided printer for printing, can print various advertisement information without consuming a large amount of manpower and material resources in advance for printing, is environment-friendly and high in timeliness, and can meet requirements of the advertisement information pushing. Moreover, after the cloud statistics is performed on the real-time printing data and the real-time working parameters, the intelligent maintenance advice or the advertisement statistical information can be outputted, the working states of the double-sided printers and the advertisement statistical information can be fed back in time, a degree of intelligence is high, and the method is efficient and fast.

### BRIEF DESCRIPTION OF THE DRAWINGS

The present disclosure is further described hereinafter with reference to the drawings and the embodiments.

FIG. 1 is a structural block diagram of a big data advertisement system for advertising through a back of cash register paper according to the present disclosure; and

FIG. 2 is a flowchart of a specific embodiment of a big data advertisement method for advertising through a back of cash register paper according to the present disclosure.

### DETAILED DESCRIPTION

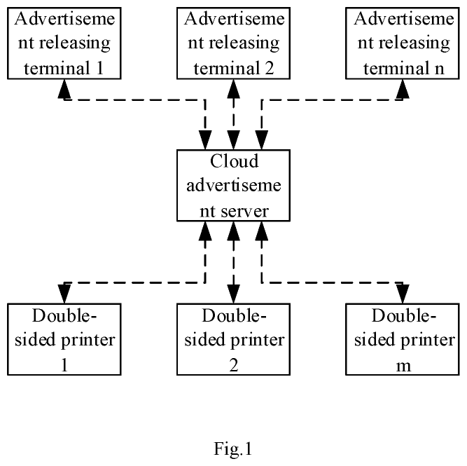

With reference to FIG. 1, a big data advertisement system for advertising through a back of cash register paper comprises a cloud advertisement server, at least one advertisement releasing terminal, and a plurality of double-sided printers, wherein the cloud advertisement server is respectively and wirelessly connected with the advertisement releasing terminal and the double-sided printers;

the advertisement releasing terminal is configured for receiving advertisement contents input by a user, generating advertisement information, and then sending the advertisement information to the cloud advertisement server;

the cloud advertisement server is configured for receiving the advertisement information sent by the advertisement releasing terminal, generating corresponding advertisement pushing information, and then sending the corresponding advertisement pushing information to the double-sided printers, and also configured for performing cloud statistics on real-time working parameters and real-time printing data of the double-sided printers, and then outputting an intelligent maintenance advice or advertisement statistical information; and

the double-sided printers are configured for receiving the advertisement pushing information and printing the corresponding advertisement information on a back of cash register paper when printing cashier information, and sending the real-time working parameters and the real-time printing data to the cloud advertisement server.

As a further preferred embodiment, the real-time working parameters of the double-sided printer include printing parameters and working parameters of various spare parts, and the real-time printing data comprises commodity information, printing time and printed advertisement contents.

As a further preferred embodiment, the real-time printing data also comprises coupon consumption information.

As a further preferred embodiment, the cloud advertisement server is configured for counting the printing parameters of the double-sided printers and the working parameters of various spare parts, and then analyzing to obtain service lives of the spare parts of the double-sided printer, a maintenance advice on the spare part, or an amending advice on the printing parameters.

As a further preferred embodiment, the cloud advertisement server is configured for counting the real-time printing data of the double-sided printers, and then calculating to obtain a main printing period, an advertisement printing ratio and an advertisement vacancy rate of the double-sided printers, and also configured for counting advertisement times of various advertisement contents printed by the double-sided printers and counting coupon consumption times corresponding to each advertisement content according to the coupon consumption information, and then calculating to obtain an advertisement feedback rate of each advertisement content.

As a further preferred embodiment, a sum of the advertisement printing ratio and the advertisement vacancy rate is 1, and a calculation method of the advertisement printing ratio is: total advertisement printing times/total printing times of the double-sided printer.

The present disclosure also provides a big data advertisement method for advertising through a back of cash register paper, which comprises:

receiving, by an advertisement releasing terminal, advertisement contents input by a user, generating advertisement information, and then sending the advertisement information to a cloud advertisement server;

receiving, by the cloud advertisement server, the advertisement information sent by the advertisement releasing terminal, then generating corresponding advertisement pushing information, and sending the advertisement pushing information to double-sided printers;

receiving, by the double-sided printers, the advertisement pushing information, analyzing the advertisement pushing information, printing the corresponding advertisement information on back of cash register paper when printing cashier information, and sending real-time working parameters and real-time printing data to the cloud advertisement server; and

performing cloud statistics, by the cloud advertisement server, on the real-time working parameters and the real-time printing data of the double-sided printers, and outputting an intelligent maintenance advice or advertisement statistical information.

As a further preferred embodiment, the real-time working parameters of the double-sided printer include printing parameters and working parameters of various spare parts, the real-time printing data comprises commodity information, printing time and printed advertisement contents, and the step of performing the cloud statistics, by the cloud advertisement server, on the real-time working parameters and the real-time printing data of the double-sided printers, and outputting the intelligent maintenance advice or the advertisement statistical information specifically comprises:

counting, by the cloud advertisement server, the printing parameters of the double-sided printers and the working parameters of various spare parts, then analyzing to obtain service lives of the spare parts of the double-sided printer, a maintenance advice on the spare parts, or an amending advice on the printing parameters, and correspondingly sending the service lives, the maintenance advice or the amending advice to the double-sided printers or a control terminal thereof;

or,

counting, by the cloud advertisement server, the real-time printing data of the double-sided printers, then calculating to obtain a main printing period, an advertisement printing ratio and an advertisement vacancy rate of the double-sided printers, and outputting the main printing period, the advertisement printing ratio and the advertisement vacancy rate to each advertisement releasing terminal.

As a further preferred embodiment, the real-time printing data also comprises coupon consumption information, and the big data advertisement method also comprises the following steps of:

counting, by the cloud advertisement server, advertisement times of various advertisement contents printed by the double-sided printers and counting coupon consumption times corresponding to each advertisement content according to the coupon consumption information, and then calculating to obtain an advertisement feedback rate of each advertisement content.

As a further preferred embodiment, in the advertisement pushing information pushed by the cloud advertisement server, each advertisement content has a corresponding advertisement code, and a data format of the real-time printing data is composed of an identification code, an advertisement identification, a data content, an advertisement code and local time information, the identification code is unique identification code of the double-sided printer, and the advertisement identification is configured for identifying whether the printing data contains the advertisement contents.

As a further preferred embodiment, the step of receiving, by the cloud advertisement server, the advertisement information sent by the advertisement releasing terminal, then generating the corresponding advertisement pushing information, and sending the advertisement pushing information to the double-sided printers specifically comprises:

receiving, by the cloud advertisement server, the advertisement information sent by the advertisement releasing terminal, then generating the corresponding advertisement pushing information, analyzing the advertisement contents in the advertisement pushing information, selecting an appropriate double-sided printer as a pushing object according to the advertisement statistical information of the double-sided printers, and sending the advertisement pushing information to all the selected double-sided printers.

As a further preferred embodiment, a sum of the advertisement printing ratio and the advertisement vacancy rate is 1, and a calculation method of the advertisement printing ratio is: total advertisement printing times/total printing times of the double-sided printer.

The present disclosure is described in detail hereinafter with reference to more specific embodiments.

With reference to FIG. 1, a big data advertisement system for advertising through a back of cash register paper comprises a cloud advertisement server, at least one advertisement releasing terminal, and a plurality of double-sided printers, wherein the cloud advertisement server is respectively and wirelessly connected with the advertisement releasing terminal and the double-sided printers; the advertisement releasing terminal is configured for receiving advertisement contents input by a user, generating advertisement information, and then sending the advertisement information to the cloud advertisement server; the cloud advertisement server is configured for receiving the advertisement information sent by the advertisement releasing terminal, generating corresponding advertisement pushing information, and then sending the corresponding advertisement pushing information to the double-sided printers, and also configured for performing cloud statistics on real-time working parameters and real-time printing data of the double-sided printers, and then outputting an intelligent maintenance advice or advertisement statistical information; and the double-sided printers are configured for receiving the advertisement pushing information and printing the corresponding advertisement information on a back of cash register paper when printing cashier information, and sending the real-time working parameters and the real-time printing data to the cloud advertisement server. FIG. 1 shows an advertisement releasing terminal 1 to an advertisement releasing terminal n and a double-sided printer 1 to a double-sided printer m, wherein n is a positive integer greater than or equal to 1, and m is a positive integer greater than or equal to 2.

The advertisement releasing terminal may be a specially configured computer, or a mobile phone with a corresponding authority, or an APP with an advertisement information releasing function. In the present disclosure, the advertisement releasing terminal mainly plays a role of an information releasing interface. When a user releases the advertisement information, the information can be sent to the advertisement releasing terminal through various intelligent terminals, edited by an operator of the advertisement releasing terminal, and then sent to the cloud advertisement server.

In the embodiment, the real-time working parameters of the double-sided printer include printing parameters and working parameters of various spare parts, and the real-time printing data comprises commodity information, printing time, printed advertisement contents and coupon consumption information.

In the advertisement pushing information, each advertisement content has a corresponding advertisement code, and a data format of the real-time printing data is composed of an identification code, an advertisement identification, a data content, an advertisement code and local time information, the identification code is unique identification code of the double-sided printer, and the advertisement identification is configured for identifying whether the printing data contains the advertisement contents. When the advertisement identification indicates that the advertisement contents are not printed in certain real-time printing data, the advertisement code is NULL. The data content refers to an actual charging content, which comprises specific commodity information, price, total price and the like, and the coupon consumption information is also included in the data content. When the cloud advertisement server performs statistics, whether the advertisement contents are included is judged according to the advertisement identification in the real-time printing data, so that total advertisement printing times can be counted.

The cloud advertisement server is configured for counting the printing parameters of the double-sided printers and the working parameters of various spare parts, and then analyzing to obtain service lives of the spare parts of the double-sided printer, a maintenance advice on the spare part, or an amending advice on the printing parameters. The cloud advertisement server is also configured for counting the real-time printing data of the double-sided printers, and then calculating to obtain a main printing period, an advertisement printing ratio and an advertisement vacancy rate of the double-sided printers, and also configured for counting advertisement times of various advertisement contents printed by the double-sided printers and counting coupon consumption times corresponding to each advertisement content according to the coupon consumption information, and then calculating to obtain an advertisement feedback rate of each advertisement content. Advertisement feedback rate=coupon consumption times/total advertisement times of advertisement contents, for example, when a coupon is an A catering coupon with 10 consumption times, an advertisement feedback rate is obtained by a formula 10/K after correspondingly obtaining advertisement times K of A catering advertisement contents. Feedback of certain specific advertisement content can be obtained statistically through the statistical method, and a customer is timely informed of the advertisement feedback.

The maintenance advice on the spare part comprises an abnormal state alarm advice on the spare part, a replacement advice on the spare part and the like. For example, when a service life of a printing head being about to run out is obtained statistically according to printing parameters of the printing head, an abnormal alarm advice on the printing head can be sent, or a replacement advice on the printing head can be sent. The amending advice on the printing parameters is a specific amending advice obtained according to the printing parameters of all the spare parts of the double-sided printer. For example, when a printing speed being too fast or too slow or a printing resolution being too low or too high are known from analysis on the printing parameters, a corresponding amending and adjusting advice can be given.

A sum of the advertisement printing ratio and the advertisement vacancy rate is 1, and a calculation method of the advertisement printing ratio is: total advertisement printing times/total printing times of the double-sided printer. After calculating the advertisement printing ratio or the advertisement vacancy rate, an advertisement utilization rate of each double-sided printer is counted, and based on big data statistics, after obtaining the advertisement utilization rate of each double-sided printer, reasonable advertisement releasing planning can be performed based on various requirements. For example, for a double-sided printer with a high advertisement vacancy rate, various types of advertisement pushing information can be pushed to the double-sided printer. In addition, advertisement vacancy rates in different industries can be further obtained statistically in combination with an application merchant of each double-sided printer according to the advertisement vacancy rate of each double-sided printer.

As long as the double-sided printer is configured in advance at each charging terminal, such as convenience store, shop, supermarket and the like, and wireless communication is established between the double-sided printer and the cloud advertisement server, the system can timely send the advertisement information to be sent to the double-sided printer for printing, and can print various advertisement information, without consuming a large amount of manpower and material resources in advance for printing, so that the advertisement information can be updated or released at any time, a timeliness is high, requirements of advertisement information pushing can be met, and environmental protection is realized, without consuming additional materials. Moreover, the method can collect the real-time printing data and the real-time working parameters of the double-sided printer and then send the real-time printing data and the real-time working parameters to the cloud advertisement server for big data statistics and big data processing. After the cloud advertisement server performs cloud statistics on the real-time printing data and the real-time working parameters, an intelligent maintenance advice or advertisement statistical information can be outputted, working states of the double-sided printers and the advertisement statistical information can be timely fed back, and a degree of intelligence is high. Moreover, the system is efficient and fast.

Correspondingly, a big data advertisement method based on the embodiment is as follows.

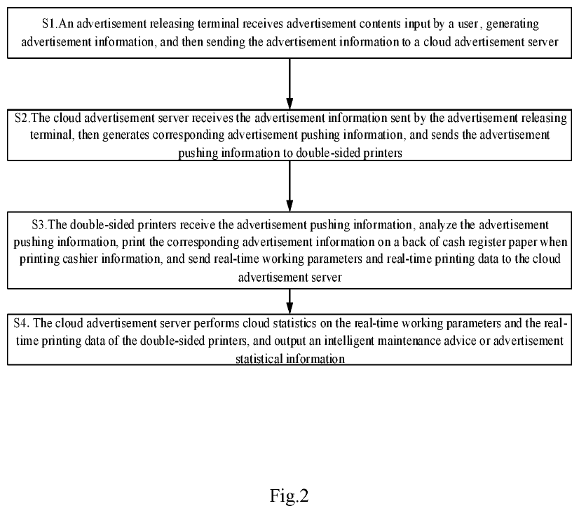

With reference to FIG. 2, the present disclosure also provides the big data advertisement method for advertising through a back of cash register paper, which comprises:

S1: receiving, by an advertisement releasing terminal, advertisement contents input by a user, generating advertisement information, and then sending the advertisement information to a cloud advertisement server;

S2: receiving, by the cloud advertisement server, the advertisement information sent by the advertisement releasing terminal, then generating corresponding advertisement pushing information, and sending the advertisement pushing information to double-sided printers;

S3: receiving, by the double-sided printers, the advertisement pushing information, analyzing the advertisement pushing information, printing the corresponding advertisement information on a back of cash register paper when printing cashier information, and sending real-time working parameters and real-time printing data to the cloud advertisement server; and

S4: performing cloud statistics, by the cloud advertisement server, on the real-time working parameters and the real-time printing data of the double-sided printers, and outputting an intelligent maintenance advice or advertisement statistical information.

In the embodiment, the real-time working parameters of the double-sided printer include printing parameters and working parameters of various spare parts, the real-time printing data comprises commodity information, printing time and printed advertisement contents, and the step S4 specifically comprises:

counting, by the cloud advertisement server, the printing parameters of the double-sided printers and the working parameters of various spare parts, then analyzing to obtain service lives of the spare parts of the double-sided printer, a maintenance advice on the spare parts, or an amending advice on the printing parameters, and correspondingly sending the service lives, the maintenance advice or the amending advice to the double-sided printers or a control terminal thereof;

or,

counting, by the cloud advertisement server, the real-time printing data of the double-sided printers, then calculating to obtain a main printing period, an advertisement printing ratio and an advertisement vacancy rate of the double-sided printers, and outputting the main printing period, the advertisement printing ratio and the advertisement vacancy rate to the advertisement releasing terminal.

The maintenance advice on the spare part comprises an abnormal state alarm advice on the spare part, a replacement advice on the spare part and the like. For example, when a service life of a printing head being about to run out is obtained statistically according to printing parameters of the printing head, an abnormal alarm advice on the printing head can be sent, or a replacement advice on the printing head can be sent. The amending advice on the printing parameters is a specific amending advice obtained according to the printing parameters of all the spare parts of the double-sided printer. For example, when a printing speed being too fast or too slow or a printing resolution being too low or too high are known from analysis on the printing parameters, a corresponding amending and adjusting advice can be given.

A sum of the advertisement printing ratio and the advertisement vacancy rate is 1, and a calculation method of the advertisement printing ratio is: total advertisement printing times/total printing times of the double-sided printer. After calculating the advertisement printing ratio or the advertisement vacancy rate, an advertisement utilization rate of each double-sided printer is counted, and based on big data statistics, after obtaining the advertisement utilization rate of each double-sided printer, reasonable advertisement releasing planning can be performed based on various requirements. For example, for a double-sided printer with a high advertisement vacancy rate, various types of advertisement pushing information can be pushed to the double-sided printer. In addition, advertisement vacancy rates in different industries can be further obtained statistically in combination with an application merchant of each double-sided printer according to the advertisement vacancy rate of each double-sided printer.

In the embodiment, the real-time printing data also comprises coupon consumption information, and the big data advertisement method also comprises:

counting, by the cloud advertisement server, advertisement times of various advertisement contents printed by the double-sided printers and counting coupon consumption times corresponding to each advertisement content according to the coupon consumption information, and then calculating to obtain an advertisement feedback rate of each advertisement content. The step may be after the step S3, and may be before or after the step S4.

Preferably, in the advertisement pushing information pushed by the cloud advertisement server, each advertisement content has a corresponding advertisement code, and a data format of the real-time printing data is composed of an identification code, an advertisement identification, a data content, an advertisement code and local time information, the identification code is unique identification code of the double-sided printer, and the advertisement identification is configured for identifying whether the printing data contains the advertisement contents. When the advertisement identification indicates that the advertisement contents are not printed in certain real-time printing data, the advertisement code is NULL. The data content refers to an actual charging content, which comprises specific commodity information, price, total price and the like, and the coupon consumption information is also included in the data content.

When the cloud advertisement server performs statistics, whether the advertisement contents are included is judged according to the advertisement identification in the real-time printing data, so that total advertisement printing times can be counted.

Preferably, the step S2 specifically comprises:

receiving, by the cloud advertisement server, the advertisement information sent by the advertisement releasing terminal, then generating the corresponding advertisement pushing information, analyzing the advertisement contents in the advertisement pushing information, selecting an appropriate double-sided printer as a pushing object according to the advertisement statistical information of the double-sided printers, and sending the advertisement pushing information to all the selected double-sided printers. The appropriate double-sided printer here refers to a double-sided printer obtained after data matching performed by the cloud advertisement server and relatively matched with the advertisement contents. For example, when certain advertisement content is mainly aimed at office workers, the advertisement content will be pushed to a double-sided printer arranged near an office building with a main printing period being working days or working hours, so as to realize targeted advertisement pushing.

Therefore, as long as the double-sided printer is configured in advance at each charging terminal, such as convenience store, shop, supermarket and the like, and wireless communication is established between the double-sided printer and the cloud advertisement server, the method can timely send the advertisement information to be sent to the double-sided printer for printing, and can print various advertisement information, without consuming a large amount of manpower and material resources in advance for printing, so that the advertisement information can be updated or released at any time, a timeliness is high, requirements of advertisement information pushing can be met, and environmental protection is realized, without consuming additional materials. Moreover, the method can collect the real-time printing data and the real-time working parameters of the double-sided printer and then send the real-time printing data and the real-time working parameters to the cloud advertisement server for big data statistics and big data processing. After the cloud advertisement server performs cloud statistics on the real-time printing data and the real-time working parameters, an intelligent maintenance advice or advertisement statistical information can be outputted, working states of the double-sided printers and the advertisement statistical information can be timely fed back, and a degree of intelligence is high. Moreover, the method is efficient and fast.

The forgoing describes the preferred embodiments of the present disclosure in detail, but the present disclosure is not limited to the embodiments. Those skilled in the art can also make various equivalent modifications or substitutions without departing from the spirit of the present disclosure, and these equivalent modifications or substitutions shall all fall within the scope defined in the claims of the present application.

What is claimed is:

1. A big data advertisement system for advertising through a back of cash register paper, comprising:
a cloud advertisement server;
at least one advertisement releasing terminal; and
a plurality of double-sided printers,
wherein the cloud advertisement server is respectively and wirelessly connected with the advertisement releasing terminal and the double-sided printers;
the advertisement releasing terminal is configured for receiving advertisement content(s) input by a user, generating advertisement information, and then sending the advertisement information to the cloud advertisement server;
the cloud advertisement server is configured for receiving the advertisement information sent by the advertisement releasing terminal, generating corresponding advertisement pushing information, and then sending the corresponding advertisement pushing information to the double-sided printers, and also configured for performing cloud statistics on real-time working parameter(s) and real-time printing data of the double-sided printers, and then outputting an intelligent maintenance advice or advertisement statistical information; and
the double-sided printers are configured for receiving the advertisement pushing information and printing the corresponding advertisement information on a back of cash register paper when printing cashier information, and sending the real-time working parameter(s) and the real-time printing data to the cloud advertisement server.

2. The big data advertisement system for advertising through the back of the cash register paper of claim 1, wherein the real-time working parameter(s) of the double-sided printer comprise printing parameter(s) and working parameter(s) of various spare parts, and the real-time printing data comprises commodity information, printing time and printed advertisement content(s).

3. The big data advertisement system for advertising through the back of the cash register paper of claim 2, wherein the real-time printing data also comprises coupon consumption information.

4. The big data advertisement system for advertising through the back of the cash register paper of claim 2, wherein the cloud advertisement server is configured for counting the printing parameters of the double-sided printers and the working parameters of various spare parts, and then analyzing to obtain service lives of the spare parts of the double-sided printer, a maintenance advice on the spare part, or an amending advice on the printing parameters.

5. The big data advertisement system for advertising through the back of the cash register paper of claim 3, wherein the cloud advertisement server is configured for counting the real-time printing data of the double-sided printers, and then calculating to obtain a main printing period, an advertisement printing ratio and an advertisement vacancy rate of the double-sided printers, and also configured for counting advertisement times of various advertisement contents printed by the double-sided printers and counting coupon consumption times corresponding to each advertisement content according to the coupon consumption information, and then calculating to obtain an advertisement feedback rate of each advertisement content.

6. A big data advertisement method for advertising through a back of cash register paper, comprising:
receiving, by an advertisement releasing terminal, advertisement content(s) input by a user, generating advertisement information, and then sending the advertisement information to a cloud advertisement server;
receiving, by the cloud advertisement server, the advertisement information sent by the advertisement releasing terminal, then generating corresponding advertisement pushing information, and sending the corresponding advertisement pushing information to double-sided printers;
receiving, by the double-sided printers, the advertisement pushing information, analyzing the advertisement pushing information, printing the corresponding advertisement information on a back of cash register paper when printing cashier information, and sending real-time working parameters and real-time printing data to the cloud advertisement server; and
performing cloud statistics, by the cloud advertisement server, on the real-time working parameters and the real-time printing data of the double-sided printers, and outputting an intelligent maintenance advice or advertisement statistical information.

7. The big data advertisement method for advertising through the back of the cash register paper of claim 6, wherein the real-time working parameters of the double-sided printer comprise printing parameters and working parameters of various spare parts, the real-time printing data comprises commodity information, printing time and printed advertisement content(s), and the step of performing the cloud statistics, by the cloud advertisement server, on the real-time working parameters and the real-time printing data of the double-sided printers, and outputting the intelligent maintenance advice or the advertisement statistical information specifically comprises:
counting, by the cloud advertisement server, the printing parameters of the double-sided printers and the working parameters of various spare parts, then analyzing to obtain service lives of the spare parts of the double-sided printer, a maintenance advice on the spare parts, or an amending advice on the printing parameters, and correspondingly sending the service lives, the maintenance advice or the amending advice to the double-sided printers or a control terminal thereof;
or,
counting, by the cloud advertisement server, the real-time printing data of the double-sided printers, then calculating to obtain a main printing period, an advertisement printing ratio and an advertisement vacancy rate of the double-sided printers, and outputting the main printing period, the advertisement printing ratio and the advertisement vacancy rate to each advertisement releasing terminal.

8. The big data advertisement method for advertising through the back of the cash register paper of claim 7, wherein the real-time printing data also comprises coupon consumption information, and the big data advertisement method also comprises:
counting, by the cloud advertisement server, advertisement times of various advertisement content(s) printed by the double-sided printers and counting coupon consumption times corresponding to each advertisement content according to the coupon consumption information, and then calculating to obtain an advertisement feedback rate of each advertisement content.

9. The big data advertisement method for advertising through the back of the cash register paper of claim 7, wherein in the advertisement pushing information pushed by the cloud advertisement server, each advertisement content has a corresponding advertisement code, and a data format of the real-time printing data is composed of an identification code, an advertisement identification, a data content, an advertisement code and local time information, the identification code is unique identification code of the double-sided printer, and the advertisement identification is configured for identifying whether the printing data contains the advertisement content(s).

10. The big data advertisement method for advertising through the back of the cash register paper of claim 8, wherein the step of receiving, by the cloud advertisement server, the advertisement information sent by the advertisement releasing terminal, then generating the corresponding advertisement pushing information, and sending the advertisement pushing information to the double-sided printers specifically comprises:
receiving, by the cloud advertisement server, the advertisement information sent by the advertisement releasing terminal, then generating the corresponding advertisement pushing information, analyzing the advertisement content(s) in the advertisement pushing information, selecting an appropriate double-sided printer as a pushing object according to the advertisement statistical information of the double-sided printers, and sending the advertisement pushing information to all the selected double-sided printers.
